(19) United States
(12) Patent Application Publication
(10) Pub. No.: US 2002/0077962 A1
(43) Pub. Date: Jun. 20, 2002

(54) Trading system and method

(76) Inventors: John O. Donato, Mendham, NJ (US); Richard M. Vesce, Manalapan, NJ (US)

Correspondence Address: Samuels, Gauthier & Stevens LLP, 225 Franklin Street, Suite 3300, Boston, MA, 02110, US

(21) Appl. No.: 09/944,520

(22) Filed: Aug. 31, 2001

Related U.S. Application Data
(60) Provisional application No. 60/229,442, filed on Aug. 31, 2000.

(51) Int. Cl. G06F 17/60

(52) U.S. Cl. 705/37

(57) ABSTRACT

A trading system is disclosed for receiving bids and offers in connection with various volumes of tradable instruments. The system includes a bid input unit for receiving bids for the tradable instrument, an offer input unit for receiving offers for the tradable instrument, a display unit and a processing unit. The display unit is for displaying at least two bids and at least two offers for the tradable instrument, one of the bids being lower than a best bid, and one of the offers being higher than a best offer. The processing unit receives hits and takes for any of the displayed bids and offers.

### BACKGROUND OF THE INVENTION

The invention relates to computerized networks that disseminate market data to users and permit users to place orders and execute trades. The invention relates in particular to systems that provide specialized trading features that permit users to manage and execute trades with more flexibility and control.

Trading systems typically provide users with best offer data and best bid data for tradable instruments in for example, the financial, energy and commodity markets. Certain systems provide such data for a variety of volumes of tradable instruments. For example, a trading system may provide best offer data and best bid data for a single particular instrument, one hundred instruments, one million instruments etc. Such systems, however, and in particular computer network trading system, typically treat each user in the same fashion regardless of their prior trading activity, and typically provide each user with a limited amount of data regarding outstanding bids and offers.

It is generally desirable for a trading system to manage and process as many trades as possible during a trading day, and to facilitate users in making such bids, offers and trades.

There is a need for a more flexible and user responsive trading system that encourages users to post bids, and encourages other users to make offers on such bids.

### SUMMARY OF THE INVENTION

A trading system is disclosed for receiving bids and offers in connection with various volumes of tradable instruments. The system includes a bid input unit for receiving bids for the tradable instrument, an offer input unit for receiving offers for the tradable instrument, a display unit and a processing unit. The display unit is for displaying at least two bids and at least two offers for the tradable instrument, one of the bids being lower than a best bid, and one of the offers being higher than a best offer. The processing unit receives hits and takes for any of the displayed bids and offers.

In certain embodiments, the system further includes a lock and load processing unit for receiving a hit or take from a first user on one of a best bid or offer, and for securing for a limited time a repeat option for the first user during which the first user may submit a further hit or take on the tradable instrument. In other embodiments, the system includes a work balance processing unit for receiving a hit or take from a first user on a displayed first bid or offer, and for applying a difference in a volume of tradable instrument of the hit or take to a second bid or offer.

### BRIEF DESCRIPTION OF THE DRAWINGS

The following description may be further understood with reference to the accompanying drawings in which:

FIG. 1 shows a functional diagram of the system architecture of a trading system of the invention;

FIG. 2 shows an example of a market window in a trading system of the invention;

FIG. 3 shows a diagrammatic illustration of a market depth order stack in accordance with a system of the invention;

FIG. 4 shows a diagrammatic illustration of the state relationships of various functions and states in accordance with a system of the invention; and

FIG. 5 shows a table of various trades and associated clearing scenarios in accordance with a system of the invention.

### DETAILED DESCRIPTION OF THE ILLUSTRATED EMBODIMENTS

The trading system of the invention is an interactive, broker assisted client/server electronic trading platform that supports electronic trading in a range of financial instruments derived from a tradable topic. A tradable topic is a specific combination of a currency and a financial product. For example, the combination of a currency (the US dollar) and a bond-based product (repo) is traded as a topic called US Dollar Repo. A topic may be split further into a series of instruments, each of which is offered as a tradable item. Each topic and the instruments derived from it are assigned unique trading codes in the system of the invention against which are stored certain market rules and conventions.

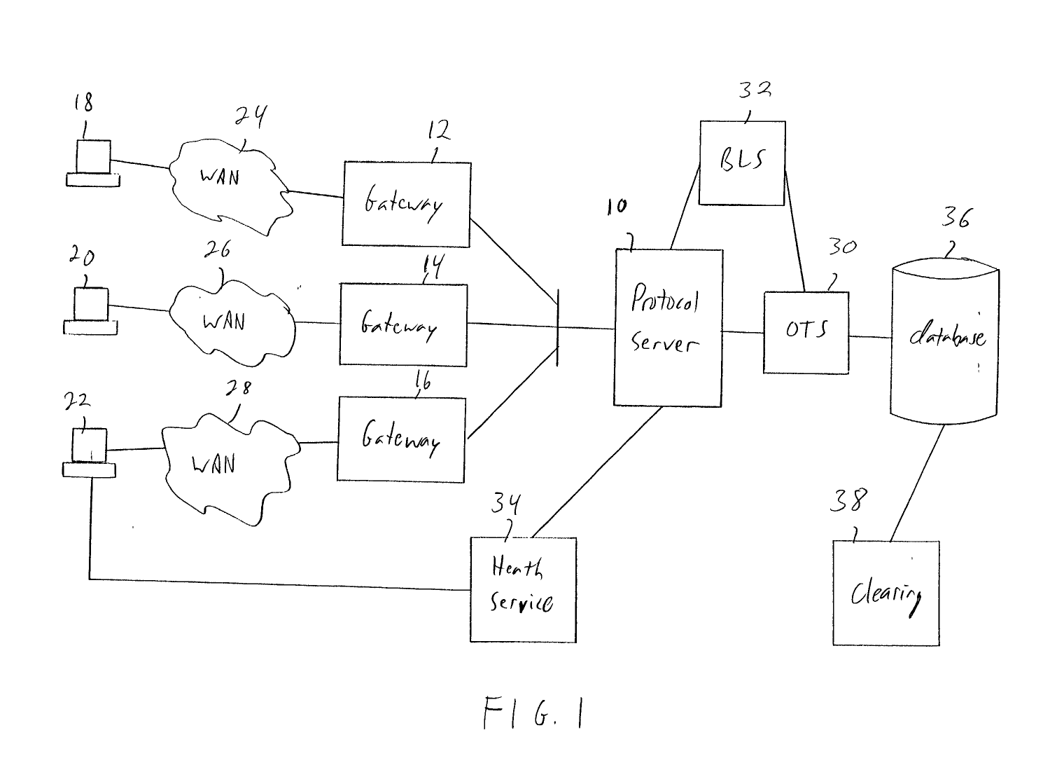

As shown in FIG. 1, a system of the invention utilizes two mechanisms for inter-process communication, namely point-to-point and publish/subscribe communication protocols. The reliable publish/subscribe protocol is used between a protocol server 10 and gateways 12, 14 and 16 for outbound messaging and allows the number of gateways 12, 14, 16 to scale without incurring additional message transmission delay. All other components communicate using point-to-point messaging in the form of either Common Object Request Broker Architecture (CORBA) Internet Inter object request broker protocol (IIOP) or native socket based connections. The gateways 12, 14, 16 communicate with user workstations 18, 20, 22 via wide area networks 24, 26, 28 as shown. The protocol server communicates with the open trading system (OTS) 30 using native socket connections between the message adapter processes and the record distribution unit. The message adaptor acts as an intermediary between the OTS 30 and the rest of the trading system. Its primary function is to map instrument requests and instrument publishes that are received from the trading system onto a corresponding set of requests and publishes that may be understood by OTS 30. Similarly, the message adaptor is responsible for converting updates that are received from OTS 30 into a set of updates that may be understood by the trading system.

The OTS 30 is a market data trading system that is platform independent and uses industry standard transmission control protocol/Internet protocol (TCP/IP) to communicate over local or wide area networks by means of a two-stage distribution architecture. The system includes distribution components, management facilities, toolkits, interfaces and feed handlers to many of the most widely used information service providers such as Reuters and Bridge.

The system also includes a business logic unit (BLS) 32 that provides the core business functionality of the trading system. The BLS 32 communicates with the rest of the trading system via the OTS distribution mechanism, and comprises the transaction server and the database interface. The transaction server accepts all orders, maintains the order book, and executes trades on behalf of clients. The transaction server preferably operates in a fault tolerant mode using a second parallel server.

The system also includes a health service naming service (HSHN) unit 34 that provides monitoring and launching features. The HSHN unit 34 provides the functionality to activate the other COBRA or Java message service (JMS) servers, monitor their state and restart them it they fail. The naming service functionality provides that the servers started by the HSHN unit 34 are identified by a unique identifier that may be used by other servers or clients to retrieve the interoperable object references (IORs) of those servers. The HSHN unit 34 also provides a load balancing mechanism that is used to even out client traffic across the gateways 12, 14, 16. The HSHN unit 34 is designed to provide fault tolerant service that replicates its state to a secondary backup that may take over if the primary system fails. The first line system for ensuring that both HSHN processes are on-line and functioning is the IOCallback mechanism. This uses the Orbix daemon to inform an object whenever a connection is established or terminated. As a further health check, the primary and secondary HSHN processes will periodically ping one another. The HSHN unit 34 is run on separate physical servers, and are activated by the Orbix deamon using the HSHN loader utility. The primary starts the secondary HSHN process.

The system also includes a database 36 that is configured to operate an Oracle v.8.05 database management system, and can utilize an Oracle Parallel Server (OPS) as an option. When a user logs in, the user service process checks the user name and password that is supplied against the contents of the user permissions table, and determines whether the user will be permitted to log on. This process functions by storing an encrypted version of the password and referencing the password against the credentials supplied by the user, ensuring that the passwords remain confidential. Whenever a user logs in or out, the user server records the event in the session history table. By interrogating the session history table, an administrator may determine who is currently logged in to the system.

The server configuration details are read from the database whenever the servers are started. Thereafter, changes to the configuration data are collected by the servers throughout the day, updating the database with any new trading codes and instruments.

In certain embodiments, the system may further include a clearing unit 38 for clearing trades, for example, for U.S. Treasury instruments such as Dollar Repos. The clearing unit 38 interfaces with a system specific trade ticket generator that generates trade tickets and fees trade date through the system. The trade feed to the trade ticket generator adheres to a pre-defined message format, which flags a trade as being blind traded or name give up. The clearing unit 38 includes a bridge component and an adaptor component, both of which may be written in JAVA. The bridge component uses JAVA Database Connectivity to communicate with the Oracle database. The adaptor communicates with the trade ticket generator via a TCP/IP socket connection to a terminal server connected to the trade ticket generator serial port.

Publish/subscribe communications within the system are provided by message broker software. The publish/subscribe model is where a message is sent to a topic (a content node known by a publisher and all active subscribers), so that all subscribers to that topic receive the message. Java message service users may tune-in, or listen, to particular channels or topics, with relevant information being received only by those particular listeners. This publish/subscribe method allows for efficient network usage and makes it possible to update large numbers of listeners very quickly. The CORBA is an industry standard distributed architecture that allows objects to communicate over a LAN/WAN network regardless of machine and operating system architecture. The CORBA IIOP protocol is used for communication between clients and gateways, and for communicating between the Health Service and he components that it monitors. It is also used by both the GSCC adapter and a Horizon Adapter. All of these components use the IONA implementation of CORBA called OrbixWeb™.

During operation, the system provides automated trading functionality to convey an order placement privilege to the passor in a trade involving the best price on one side of the market in a specific instrument. A bid is an order to buy a specific amount of an instrument at a specific price. An offer is an order to sell a specific amount of an instrument at a specific price. A passor is the counterparty that has passively supplied an order to the screen and now has had that order traded upon. A counteparty is a user or customer that is participating in a trade, i.e., the buyer and seller. An aggressor is the counterparty that initiates a trade by trading on an order that had been displayed on screen by a passor. The instrument is the underlying commodity to be traded, e.g., a bond, equity, energy contract etc. Trading takes place only when an aggressor initiates a hit against a bid to sell or a take against an offer to buy. The system does not automatically match passive bids and offers that have the same price for a number of reasons. For example, the best offer customer may not wish to trade with the best bid customer due to size and price considerations. Also, aggressors must pay commissions on all executed trades, regardless of whether or not the trades are advantageous. The trades may be untenable due to naming or credit considerations, and lastly, the trading rules may preclude a trade that appears to be only superficially tenable.

The system displays all markets on an anonymous basis, but does highlight a user's orders on his or her terminal screen. The highlight mechanism allows the user to see the order's position in the market. The users enter orders, manage orders and execute trades through a GUI (Graphical User Interface). There are two different versions of the Client GUI, called ‘Classic’ and ‘Repo’, both of which operate as applications on the trader's workstation. The Repo GUI has been designed to use less screen real estate than the Classic version, and provides essentially the same functionality as the Classic GUI, but includes some important additional functionality to support Dollar Repo trading. The Repo GUI consists of the market frame, the input frame, the orders frame, the modify orders frame, the trade history frame, the trade details frame, the instrument summary frame, and the messages frame.

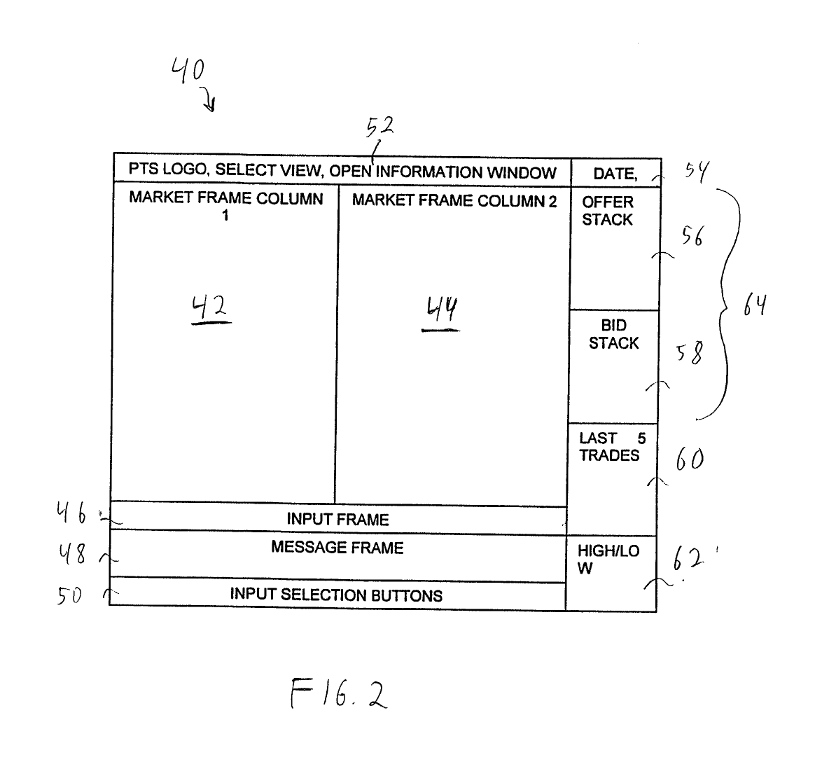

As shown in FIG. 2, the market frame 40 includes two market frame columns 42 and 44, as well as an input frame 46, a message frame 48, input selection buttons 50, and a system logo, select view, and open information window frame 52 along the top. Along the right side, the market frame 40 includes a date frame 54, an offer stack 56, a bid stack 58, a last five trades window 60, and a high/lo window 62. Selection options along the top of the market frame permit a user to select up to two pages of data. One of these pages may be a broker configured fixed page (having two columns) that the user will be unable to modify. The user will be able to build and configure a custom second page. The pages the trader views in the market window are saved to a central database as a trader's profile. This gives the trader the capability of logging into different workstations without having to recreate his profile each time. After login, the user profile automatically loads, populating the market window. The fixed page is always displayed first and is the active window.

The market frame 40 permits users to view information regarding the best bid and offer, the bid and offer amounts, the bid and offer yields, and the last reported trade for a variety of securities. The market frame is the area of the user's screen that displays the best price for instruments and the level that is trading. The trader's own orders are highlighted in colors, which indicate their position in the order book. The input frame permits users to enter an order. The orders frame permits users to view his or her open orders. The modify orders frame provides an interface through which a user can modify an existing order. The trade history frame provides an interface through which a user may view their own trades made during the day. The trade details frame provides an interface through which a user may view full trade details for a particular trade displayed in the trade history frame. The instrument summary frame provides an interface through which a user may view the best five bids, the best five offers, the last five trades, the high trade for the day, and the low trade for the day for the selected security. The message frame 48 provides an interface through which a user may view messages sent through the system.

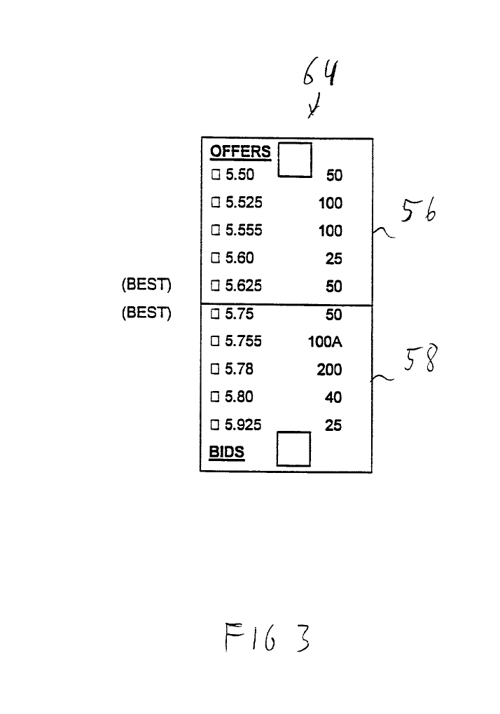

The name of the selected instrument may be displayed, as well as its market depth or stack. As shown in FIG. 3, the stack 54 displays orders up to the best five bids and up to the best five offers in the market for the selected instrument. The best 5 bid orders (sorted by best on top) and the amount of each order will appear on the bottom. The best five offer orders (sorted by best on bottom) and the amount of each order will appear at the top. All of the system pinpoint highlight symbols are displayed in the bid and offer stacks.

Below the market depth stack 64 is the trade history window 60, which displays up to the last five trades and the high and low trade frame 62, which displays the high and low trades for the day for the selected instrument. The information will include the time, price, action and amount.

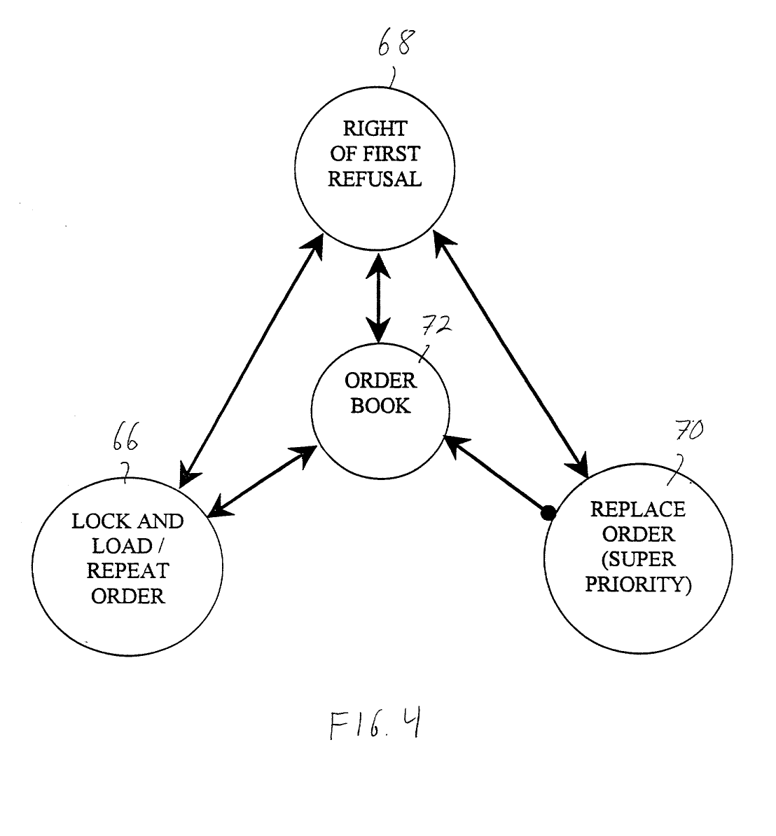

The system provides enhanced functionality to traders in the Dollar Repo market. These functions provide in-built trading advantages to system users. As shown in the relationship diagram of FIG. 4, the system utilities include a series of market conventions, including lock & load/repeat order functions 66, right of first refusal functions 68, and replace order functions 70, each of which communicate with an order book 72. The system utilities also include a set of quote trading commands, including trading of individual quotes within the stack, bypassing price and time prioritization, as well as configurable middle-of day-processing times, with additional support for cash, regular and other relative settlement day rules.

For other instruments, the system prioritizes existing orders on a price-then-time basis. An aggressive hit or take will always be matched with the best bid or offer first. Where more than one user has entered a bid or offer at the same price, the user who entered the order first will have priority. A user may modify a bid or offer by lowering the quantity specified without losing time priority. A user may modify an existing bid or offer by increasing the specified quantity without losing time priority on the original quantity specified. The remainder will be treated as a new order and will be time-stamped with the time when the modified order was submitted.

Trades occur when a user hits a bid or takes an offer. A user may hit a bid or take an offer that causes another user's existing bid or offer to be filled either fully or only partially, depending on the size. Likewise, a user may hit a bid or take an offer that causes more than one user's bid or offer to be filled. Trade commissions are always charged to the users entering the hit or take (the aggressors).

The system also provides functionality to convey an order placement privilege to the aggressor in a trade involving the best price on one side of the market in a specific instrument. Further, the system provides functionality to give aggressor users the opportunity to specify that any unfilled balance in a trade should be submitted as an order at that trading level.

The lock and load feature becomes available when the best bid or offer price for a specific instrument is traded. The lock and load features are not invoked if the trade does not involve the best price. The system may operate with or without the lock and load feature, with both the repeat and replace feature, or with the replace feature alone.

When a trade is executed, the market frame of the screen displays the traded price levels, total size at each level and the letter H or T to indicate hit or take. A hit is the action of selling a specific amount of an instrument at a specific price. A take is the action of buying a specific amount of an instrument at a specific price. This display flashes and shows the levels in order starting with the best level.

For a predetermined time, known as the repeat period, the passor is given the right but not the obligation to submit a repeat order on the same side of the market on the same instrument that has just traded. The repeat period is the time during which a repeat order may be submitted. The repeat order may be at any price and in any size, within pre-configured market limits. The repeat order, however, is given priority over all existing orders and those orders submitted by other parties during the repeat period in that it is automatically promoted to top of the stack for that price level. The stack is a list of orders to buy and sell a specific instrument. The stack is usually ordered by price, best price first, then time, earliest order at the price first. However, the lock and load feature may override this as discussed below. The best order is the order that is at the top of the stack.

During this period, all customers may enter new orders or amend existing ones on the instrument subject to lock and load. However, changes to orders on the side of the market that the repeat feature is applied to will not be displayed in the market until the termination of the repeat period. During this period that stack on the side subject to the repeat feature is not displayed to any market participants. The repeat period is terminated either when the configurable time period has passed since the initial trade or a repeat order has been placed. When the period is terminated the last traded price flashing in the market frame disappears. If there is a new best price on the repeat side of the market and that price was submitted by the counterparty acting under the repeat feature it will be cleared to the counterparty showing the best price on the other side of the market. If the new best price is not from the repeating counterparty clearing is not initiated.

The replace feature is initiated whenever the repeat feature is initiated when replace has been enabled. This feature applies to the aggressor to the trade. During the replace period the aggressor may submit an order on the opposite side of the market to that which is traded. The replace period is the time period during which a replace order may be submitted. This order will be given the same priority over all existing orders and those orders submitted by other parties during the replace period in that it is automatically promoted to top of the stack for that price level. This replace order may be automatically generated if the counterparty has used the work balance feature in the original trade. The work balance feature allows an aggressor to automatically generate an order to offer a bid for any remainder left over from his attempt to trade.

The replace time is terminated in one of three ways; the pre-configured replace time has elapsed, a replace order has been submitted either manually or as a work balance order or the repeat time has been terminated. It is important to note that this last condition means that the aggressor must act quickly to submit a replace order as the submission of a repeat order by the other counterparty will result in the replace time being terminated.

The work balance feature is activated by an aggressor when he or she is entering details of the trade that he or she wishes to execute through the action frame. This is done by ticking a box marked “WB” for work balance. With WB ticked, a trade that is entered will be filled against existing orders until either the whole size is done or there is no more size available at levels equal or better than the order's price limit. In the first case, as the whole size is filled there is no balance to be worked, therefore, the WB feature has no effect. In the latter case there will be a balance of the trade left to execute but no suitable orders for it to be traded against. In this case, the balance and the limit price are used to generate a new order on behalf of the aggressor. This order behaves in exactly the same way as a regular manually entered order. If the second scenario is repeated without WB ticked it results in the untraded balance being discarded from the system.

The system includes a transaction server that matches passive orders (a bid to buy a particular instrument at a price or an offer to sell an instrument at a price) against aggressive orders (a hit against a bid to sell an instrument, or a take against an offer to buy an instrument). The system maintains an order book of existing passive orders (bids and offers) for each instrument on a transaction server. Orders are ranked first by price, and then, if there is more than one order for an instrument at the same price, by time. This is called ‘price-then-time’ priority. This stack order is usually governed by the price of an order followed by the time that it is submitted. As aggressors pay commissions, the system does not automatically match passive bids and offers at the same price. Trading will not occur in the absence of an aggressor initiating a hit or a take. The trading rules and structures are applicable to the classes of system users and user permissions; the way in which the system manages and prioritizes orders and trades; the rules of entry for orders and trades; market-specific conventions and associated rules; quote trading commands and rules; the structure of the trading day and trading day rules; and settlement and clearing of trades rules.

The system trading rules, therefore, provide unique incentives to users. Unlike conventional systems that provide an order book that is made up of only one best bid, the system of the invention enables users to enter live orders at levels other than a best bid or offer, and keeps those orders alive for as long as the user desires during that trading day. If market prices move, a standing order in the order book may enjoy status privileges of right of first refusal or lock and load by simply remaining in the order book until that incentive is initiated.

The diagram of FIG. 4 illustrates the relationship between the incentive management trading rules in the system and the order book 72. Users may move from the order book 72 to first refusal 68, or the reverse; lock and load/repeat 66 to the order book 72, or the reverse. Users may also move from the first refusal 68 to the lock and load/repeat 66, and the reverse, and from the first refusal 68 to the replace order 70, and the reverse. Users may also move from the replace order 70 (having very high priority) to the order book 72, but may not move in the reverse direction as shown.

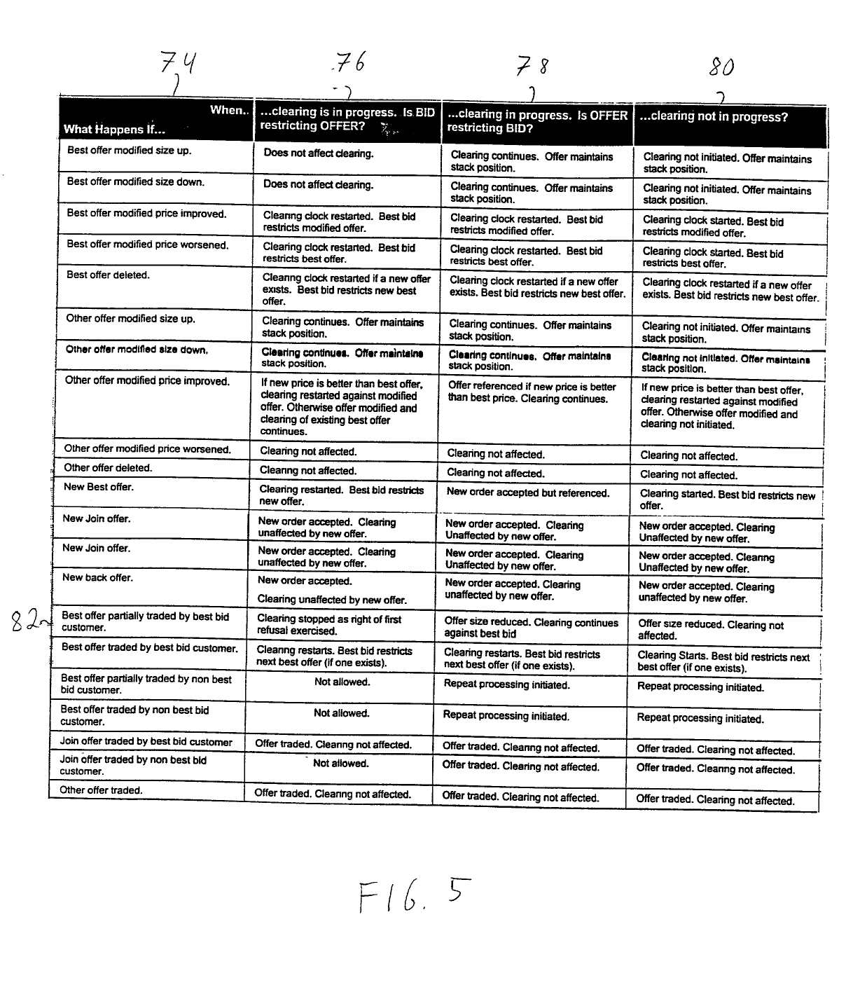

FIG. 5 shows a series of permitted bid/offer scenarios that may occur between traders using a system of the invention. The table shows how these scenarios affect the process of clearing a trade and also how the types of bid and offer affect one another. The effects of the system clearing rules and conventions apply equally to bids and offers, and the table of FIG. 5 should be read with the following understandings. First, bids and offers are interchangeable in the table. Second, a user does not get right of first refusal against their own counter order. Third, the right of first refusal is granted against the best live counter order, regardless of size considerations, e.g., an all-or-nothing (AON) order or a small order.

As shown in FIG. 5, if an event listed in a particular row of column 74 occurs when clearing is in progress and the bid is restricting an offer, then the result is shown in the corresponding row of column 76. If an event listed in a row of column 74 occurs when clearing is in progress and the offer is restricting a bid, then the result is shown in the corresponding row of column 78. If an event listed in a row of column 74 occurs when clearing is not in progress, then the result is shown in the corresponding row of column 80. For example, with reference to row 82 and column 74, if a best offer is partially traded by a best bid customer when clearing is in progress and the bid is restricting an offer (column 76), then clearing is stopped as right of first refusal is exercised. If this occurs when clearing is in progress and the offer is restricting the bid (column 78), then the offer size is reduced and clearing continues against the best bid. If this occurs when clearing is not in progress (column 80), then the offer size is reduced and clearing is not affected.

Those skilled in the art will appreciate that numerous further modifications and variations may be made to the above disclosed embodiments without departing from the spirit and scope of the present invention.

What is claimed is:

1. A trading system for receiving bids and offers in connection with various volumes of tradable instruments, said system comprising:
bid input means for receiving bids for the tradable instrument;
offer input means for receiving offers for the tradable instrument;
display means for displaying at least two bids and at least two offers for the tradable instrument, one of said bids being lower than a best bid, and one of said offers being higher than a best offer; and
processing means for receiving hits and takes for any of the displayed bids and offers.

2. A trading system as claimed in claim 1, wherein said display means displays five bids and five offers, and said processing means receives offers and bids for any of the displayed bids and offers.

3. A trading system for receiving bids and offers in connection with various volumes of tradable instruments, said system comprising:
bid input means for receiving bids for the tradable instrument;
offer input means for receiving offers for the tradable instrument;
display means for displaying at least two bids and at least two offers for the tradable instrument, one of said bids being lower than a best bid, and one of said offers being higher than a best offer; and
lock and load processing means for receiving a hit or take from a first user on one of a best bid or offer, and for securing for a limited time a repeat option for the first user during which the first user may submit a further hit or take on the tradable instrument.

4. A trading system as claimed in claim 3, wherein said system further includes replace processing means for permitting the first user to submit an order on the opposite side of the market to that which is traded.

5. A trading system for receiving bids and offers in connection with various volumes of tradable instruments, said system comprising:
bid input means for receiving bids for the tradable instrument;
offer input means for receiving offers for the tradable instrument;
display means for displaying at least two bids and at least two offers for the tradable instrument, one of said bids being lower than a best bid, and one of said offers being higher than a best offer; and
work balance processing means for receiving a hit or take from a first user on a displayed first bid or offer, and for applying a difference in a volume of tradable instrument of the hit or take to a second bid or offer.
